(19) United States
(12) Patent Application Publication
(10) Pub. No.: US 2026/0141503 A1
(43) Pub. Date: May 21, 2026

(54) DISPLACEMENT SENSING DEVICE FOR BUILDING STRUCTURE, DISPLACEMENT SENSING METHOD FOR BUILDING STRUCTURE, AND STORAGE MEDIUM

(71) Applicants: SHENZHEN TECHNOLOGY INSTITUTE OF URBAN PUBLIC SAFETY, Shenzhen (CN); SHENZHEN SCIENCE AND TECHNOLOGY INSTITUTE OF URBAN SAFETY DEVELOPMENT, Shenzhen (CN)

(72) Inventors: Zhongqi SHI, Shenzhen (CN); Zhisen TAN, Shenzhen (CN); Nan JIN, Shenzhen (CN); Qingrui YUE, Shenzhen (CN); Yanbing ZHOU, Shenzhen (CN); Hong FAN, Shenzhen (CN)

(73) Assignees: SHENZHEN TECHNOLOGY INSTITUTE OF URBAN PUBLIC SAFETY, Shenzhen (CN); SHENZHEN SCIENCE AND TECHNOLOGY INSTITUTE OF URBAN SAFETY DEVELOPMENT, Shenzhen (CN)

(21) Appl. No.: 19/450,665

(22) Filed: Jan. 15, 2026

Related U.S. Application Data
(63) Continuation-in-part of application No. PCT/CN2025/070187, filed on Jan. 2, 2025.

(30) Foreign Application Priority Data
Jan. 8, 2024 (CN) 202410022458.0

(51) Int. Cl. G06T 7/00; G01M 7/02; G06T 3/4007; G06T 3/4053; G06T 5/20; G06T 5/70; G06T 7/80

(52) U.S. Cl. CPC G06T 7/0002; G01M 7/025; G06T 3/4007; G06T 3/4053; G06T 5/20; G06T 5/70; G06T 7/80; G06T 2207/10016; G06T 2207/20016; G06T 2207/30184

(57) ABSTRACT

A displacement sensing device for a building structure, a displacement sensing method for a building structure, and a storage medium are provided. The displacement sensing device includes: a fixed module, a projection module and a camera module. The fixed module includes a fixed base and a fixed bracket. The fixed base is configured to be coupled with a monitoring point of a measured structure to form a structural whole. The camera module is disposed in front of the projection module at an angle of a vertical field of view via the fixed bracket, and the camera module is configured to acquire a laser image formed on the projection module by a laser emission module disposed at a fixed point.

### CROSS-REFERENCE TO RELATED APPLICATIONS

This application is a continuation application of International Application No. PCT/CN2025/070187, filed on Jan. 2, 2025, which claims priority to Chinese Patent Application No. 202410022458.0, filed on Jan. 8, 2024. The disclosures of the above-mentioned applications are incorporated herein by reference in their entireties.

### TECHNICAL FIELD

The present application relates to the field of building inspection, and in particular, to a displacement sensing device for a building structure, a displacement sensing method for a building structure, and a storage medium.

### BACKGROUND

In the field of high-rise building measurement, compared with traditional contact measurement methods, visual-based vibration measurement technology can utilize cameras or sensors to capture displacement information of a surface of an object under vibration to achieve vibration measurement. Meanwhile, visual-based vibration measurement technology has the advantages of high measurement accuracy, long monitoring distance, no need for direct contact with the measured object, and low monitoring cost.

In related visual displacement measurement methods combined with laser projection technology, a rotation effect often exists in practical applications: in addition to translational displacement, the surface of the structure also has a rotation angle. Since the projection distance of the laser light is long, even a minute rotation angle will be magnified by the projection distance, producing a large displacement change. As a result, the measured vibration displacement is a coupling of the displacement caused by the angular effect and the real translational displacement, eventually leading to the submergence of real translational information. Therefore, current visual displacement measurement methods suffer from the problem of rotation coupling.

The above content is only configured to assist in understanding the technical solution of the present application and does not represent an admission that the above content is related art.

### SUMMARY

The main objective of the present application is to provide a displacement sensing device for a building structure, so as to solve the problem of rotation coupling existing in visual displacement measurement methods in the related art.

To achieve the above objective, the present application provides a displacement sensing method for a building structure, applied to a displacement sensing device for a building structure. The displacement sensing device includes a fixed module, a projection module, a camera module, and a processor module. The fixed module includes a fixed base and a fixed bracket, and the fixed base is configured to be coupled with a monitoring point of a measured structure to form a structural whole. The camera module is disposed in front of the projection module at an angle of a vertical field of view via the fixed bracket, and the camera module is configured to acquire a laser image formed on the projection module by a laser emission module disposed at a fixed point. The processor module is configured to acquire image data collected by the camera module and generate a displacement detection result according to the image data. The displacement sensing method for the building structure includes:
acquiring the image data collected by the camera module and calibration data prestored in the processor module;
determining a partial derivative array of the image data, and calculating a gradient magnitude matrix and a gradient direction matrix of the image data according to the partial derivative array;
determining a magnitude mapping array corresponding to the gradient magnitude matrix, and determining a direction mapping array corresponding to the gradient direction matrix;
selecting target calibration data having a maximum mapping relationship value from the calibration data based on the magnitude mapping array and the direction mapping array, and determining a calibration parameter corresponding to the target calibration data;
performing super-resolution reconstruction processing on the image data based on the calibration parameter to obtain reconstructed image data; and
performing structural vibration magnification processing on the reconstructed image data, and generating a displacement detection result of the measured structure according to the target reconstructed image data after the structural vibration magnification processing.

Besides, in order to achieve the above objective, the present application further provides a displacement sensing device for a building structure, including a memory, a processor and a displacement sensing program for a building structure stored in the memory and executable on the processor. When the displacement sensing program for the building structure is executed by the processor, the steps of the displacement sensing method for the building structure as described above are implemented.

Besides, in order to achieve the above objective, the present application further provides a computer-readable storage medium storing a displacement sensing program for a building structure, which, when executed by a processor, implements the steps of the displacement sensing method for the building structure as described above.

The embodiments of the present application provide a displacement sensing device for a building structure, a displacement sensing method for a building structure, and a storage medium. The displacement sensing device includes a fixed module, a projection module and a camera module. The fixed module includes a fixed base and a fixed bracket. The fixed base is configured to be coupled with a monitoring point of a measured structure to form a structural whole. The camera module is disposed in front of the projection module at an angle of a vertical field of view via the fixed bracket, and is configured to acquire a laser image formed on the projection module by a laser emission module disposed at a fixed point. It can be seen that the sensing device fixes the relative positions of the camera module, the projection module, and other modules, and is installed at the position of the vibration monitoring point of the structure; the laser emission module is installed at a fixed point far away from the structure. Since the translational movement of the beam position generated by the minute rotation angle of the structure at this time is related to the fixed height of the projection module rather than the laser projection distance, and the fixed height of the projection module is much smaller than the laser projection distance, the problem of translational movement of the laser beam position caused by the minute rotation angle of the structure can be significantly reduced, thereby solving the problem of rotation coupling existing in the conventional “laser-vision” technology.

### BRIEF DESCRIPTION OF THE DRAWINGS

The accompanying drawings here are incorporated into the specification and form a part of this specification, showing embodiments consistent with the present application, and are configured together with the specification to explain the principles of the present application. To more clearly describe the technical solutions in the embodiments of the present application, the accompanying drawings required for the description of the embodiments will be briefly introduced below. Obviously, for those of ordinary skill in the art, other drawings can be obtained based on these drawings without creative efforts.

FIG. 1 is a schematic structural view of a displacement sensing device for a building structure of the present application.

FIG. 2 is a schematic diagram of a displacement recognition technology of a displacement sensing method for a building structure of the present application.

FIG. 3 is a schematic flowchart of a displacement sensing method for a building structure according to an embodiment of the present application.

FIG. 4 is a schematic flowchart of a displacement sensing method for a building structure according to an embodiment of present application.

FIG. 5 is a schematic flowchart of a displacement sensing method for a building structure according to an embodiment of the present application.

FIG. 6 is a schematic flowchart of a displacement sensing method for a building structure according to an embodiment of the present application.

FIG. 7 is a schematic diagram of a terminal hardware structure according to various embodiments of a displacement sensing method for a building structure of the present application.

The realization of the objectives, functional features, and advantages of the present application will be further described with reference to the accompanying drawings in combination with the embodiments.

### DETAILED DESCRIPTION OF THE EMBODIMENTS

It should be understood that the specific embodiments described herein are only configured to explain the present application and are not intended to limit the present application.

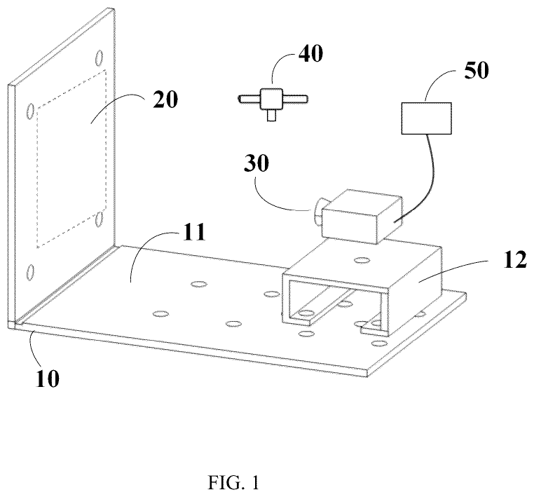

Referring to FIG. 1, in an embodiment of the present application, a schematic structural diagram of a displacement sensing device for a building structure is proposed. The displacement sensing device for the building structure includes a fixed module 10, a projection module 20, a camera module 30, a laser emission module 40, and a processor module 50. The fixed module 10 includes a fixed base 11 and a fixed bracket 12. The fixed base 11 is configured to be coupled with a monitoring point of a measured structure to form a structural whole. The camera module 30 is disposed in front of the projection module 20 at an angle of a vertical field of view via the fixed bracket, and is configured to acquire a laser image formed on the projection module 20 by the laser emission module 40 disposed at a fixed point. The camera module 30 adopts a high-resolution camera.

In addition, as shown in FIG. 1, the displacement sensing device further includes a processor module 50. The processor module 50 is configured to acquire image data collected by the camera module 30 and generate a displacement detection result according to the image data.

It should be noted that the fixed module 10 fixes the projection module 20 and the camera module 30, and fixes the camera module 30 in front of the projection module 20 at an angle of an orthographic 90° vertical field of view. Through the angle of the orthographic 90° vertical field of view, the influence of a deflection angle on vibration pixel imaging can be effectively avoided. After the fixed base 11 is installed on the measured structure, the laser emission module 40 is installed at a fixed point away from the monitoring point of the structure. For example, it can be installed below and away from the monitoring point of the structure to emit laser light upward toward the projection module 20.

Based on this, when the measured structure undergoes minute vibration, the measured structure drives the installed sensing device to vibrate together. At this time, the relative position between the device and the projected laser beam changes. Since the laser beam has no displacement, a movement of the laser beam is formed on the projection module. The direction of the movement is opposite to the direction of the minute vibration of the structure, and the amplitude is equal. Meanwhile, fixing and installing the camera module 30 in front of the projection module 20 significantly shortens the monitoring distance compared with the conventional method of deploying a camera far away from the structure, thereby significantly improving the recognition resolution of the moving picture of the laser beam and achieving high-resolution sensing of the minute displacement of the structure.

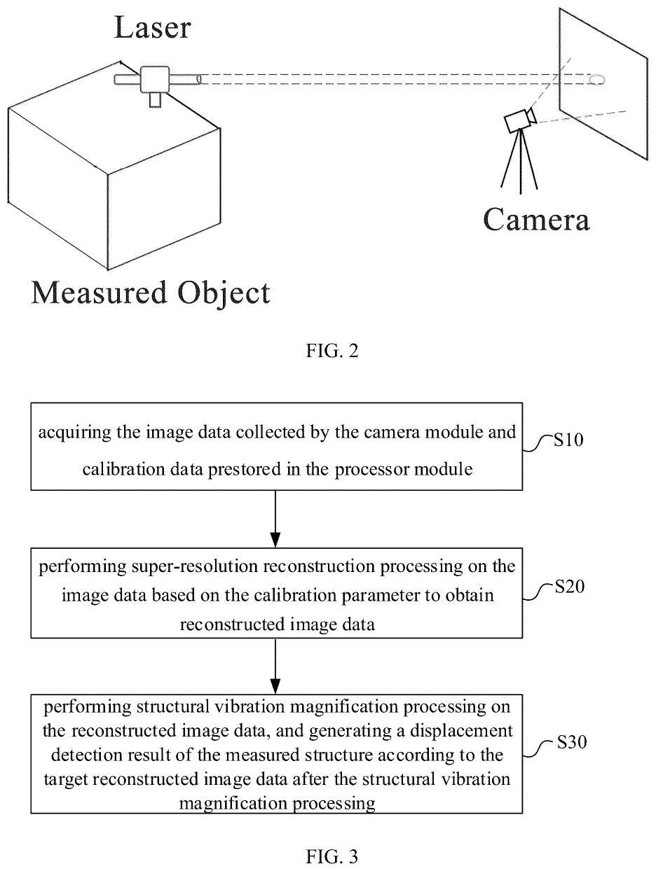

Further, referring to FIG. 2, in the related “laser-vision” displacement measurement and recognition technology, a laser lamp is usually installed on a building (i.e., an object to be measured), and image data of the measured object during vibration is captured by a remote camera, so as to calculate the minute vibration displacement of the object. However, when measuring the minute displacement of the measured object, the measurement distance is relatively long, and the corresponding displacement change formula is as follows: Δx=L×Δθ. Based on this, since the measurement distance is relatively long, the vibration measurement result is greatly affected by the change in the rotation angle. In the sensing device of this embodiment, the fixed module is directly installed on the structure to be measured, and the laser emission module is installed at a distant fixed point. At this time, the beam translation generated by the minute rotation angle of the structure is irrelevant to the laser projection distance, but is related to the distance between the camera module 30 and the projection module 20. When measuring the minute vibration of the structure, the distance between the position of the laser emission module and the displacement sensing device is much larger than the distance between the camera module 30 and the projection module 20. Therefore, the positional translation generated by the minute rotation angle of the structure is negligible. At this time, the problem of translational movement of the laser beam position caused by the minute rotation angle of the structure can be significantly reduced, solving the problem of rotation coupling existing in the current “laser-vision” technology.

In one embodiment, based on the displacement sensing device for a building structure described in the above embodiment, a displacement sensing method for a building structure is proposed. Referring to FIG. 3, the displacement sensing method for a building structure of the present application includes:

Step S10: acquiring image data collected by a camera module and calibration data prestored in a processor module.

In this embodiment, the calibration data refers to accurate data for reference measured indoors before installing the displacement sensing device on the building structure to be measured. The calibration data includes laser beam imaging data under different resolutions and different blur conditions, and regression parameters corresponding to a linear regression model between imaging data of different resolutions under different blur conditions and high-resolution laser beam imaging data. The regression parameter is configured to perform super-resolution reconstruction processing on the image data, and the imaging data under different resolutions and different blur conditions all have a regression parameter corresponding thereto. The calibration data is prestored in the processor module. The image data refers to a vibration video of the laser beam collected by the camera module. When processing the image data, processing is performed sequentially from the first frame image of the vibration video until each frame image is processed.

After installing the displacement sensing device on the measured structure and controlling the laser emission module to emit a laser beam to the projection module, the beam movement image data formed on the projection module by the laser beam when the measured structure undergoes minute vibration is acquired through the processor module of the displacement sensing device using the camera module. The measured structure includes large buildings such as large office buildings, high-rise residential buildings, and bridges.

Step S20: performing super-resolution reconstruction processing on the image data according to the calibration data to obtain reconstructed image data.

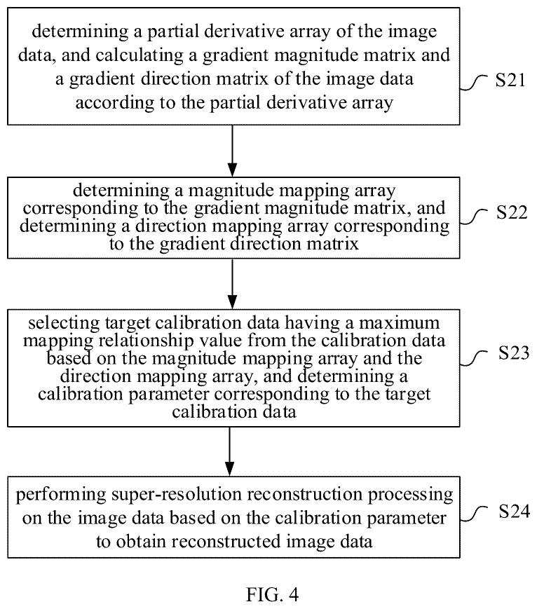

In this embodiment, in order to improve the measurement accuracy of the minute vibration of the measured structure, it is necessary to calculate the image corresponding to the super-resolution reconstruction in a certain frame of the collected image according to the calibration parameter in the calibration data, so that the processing module can output an image with higher resolution, thereby realizing reconstruction processing on the collected image to improve the recognition and measurement accuracy of minute vibration. It should be noted that in the process of performing reconstruction processing on the image data, it is necessary to calculate the gradient array of the image data, and then select the most appropriate calibration parameter in the calibration data for super-resolution reconstruction according to the image gradient array and the mapping array corresponding to the image gradient array. Therefore, referring to FIG. 4, performing super-resolution reconstruction processing on the image data according to the calibration data to obtain reconstructed image data specifically includes:

Step S21: determining a partial derivative array of the image data, and calculating a gradient magnitude matrix and a gradient direction matrix of the image data according to the partial derivative array.

As an optional implementation, a first-order finite difference can be configured to calculate the partial derivative array of the image data:

$${D}_{x} \approx ( S ( x , y + 1 ) - S ( x , y ) + S ( x + 1 , y + 1 ) - S ( x + 1 , y ) ) / 2 ;$$

$${D}_{y} \approx ( S ( x , y ) - S ( x + 1 , y ) + S ( x , y + 1 ) - S ( x + 1 , y + 1 ) ) / 2 ;$$

where Dₓ is the image partial derivative array along the x direction, and D_{y} is the image partial derivative array along the y direction.

Subsequently, combining the partial derivative arrays in the x and y directions, the image gradient array is calculated.

$$M ( x , y ) = \sqrt{{{D}_{x} ( x , y )}^{2} + {{D}_{y} ( x , y )}^{2}} ;$$

$$θ ( x , y ) = arctan ( {D}_{y} ( x , y ) / {D}_{x} ( x , y ) ) ;$$

where M represents the gradient magnitude size, and θ represents the gradient direction.

For example, the first frame of the vibration image can be processed to sequentially obtain the gradient magnitude matrix and gradient direction matrix of the frame image.

Step S22: determining a magnitude mapping array corresponding to the gradient magnitude matrix, and determining a direction mapping array corresponding to the gradient direction matrix.

When selecting the most appropriate calibration parameter from the calibration data to perform super-resolution reconstruction on the currently collected frame of image data, it is necessary to comprehensively consider the weight ratios of the mapping relationship array of the gradient magnitude matrix and the mapping relationship array of the gradient direction matrix. Therefore, in this process, it is also necessary to determine the magnitude mapping relationship array and the direction mapping relationship array corresponding to the magnitude matrix and direction matrix of the frame image in the calibration data.

In an optional implementation for determining the magnitude mapping array corresponding to the gradient magnitude matrix, a prestored gradient magnitude matrix corresponding to the calibration data within the current resolution can be determined. Subsequently, normalization processing is performed on the prestored gradient magnitude matrix and the gradient magnitude matrix, and a mapping value of each pixel position of the normalized gradient magnitude matrix in the normalized prestored gradient magnitude matrix is determined, as well as a magnitude mapping matrix corresponding to the mapping value. Finally, summation and averaging processing is performed on the mapping relationships of all rows and columns of the magnitude mapping matrix to obtain the magnitude mapping array. The current resolution refers to the resolution corresponding to when the camera module collects the image data of the projection module, that is, the resolution used when collecting image data. Since the calibration data includes images under different blur conditions and different resolutions, if the current camera resolution is 50 frames, the corresponding calibration data may be images between 45 frames and 55 frames in the calibration data. Selecting image data of 45-55 frames can be dynamically set according to the actual application scenario or the actual resolution of the camera. The images corresponding to the calibration data store corresponding gradient magnitude matrices and gradient direction matrices. The mapping relationship feature numerical value of each position of the magnitude mapping array corresponds to the calibration data under different blur conditions and different resolutions respectively.

For example, if the current collection resolution of the camera module is 60 frames, calibration images of 55 frames to 65 frames need to be selected from the calibration data. Then, using the prestored gradient magnitude matrices corresponding to these images as the matching template I₁, and using the first vibration image of the structural minute vibration beam image collected by the camera module (i.e., the gradient magnitude matrix corresponding to the currently processed image data) as the tracking template T₁, normalization processing is performed on the two templates respectively to obtain normalized templates T₁′ and I₁′. Then, the tracking template T₁ is slid on the matching template I₁ from left to right and from top to bottom, moving one pixel position at a time and calculating the mapping value of the position, to finally calculate and obtain the mapping matrix R1′. Then, summation and averaging processing is performed on the mapping relationship numerical values of each row and each column of the mapping matrix R1′ respectively to obtain the mapping relationship feature array {r′} of the magnitude.

It should be noted that the mapping relationship feature numerical value of each position corresponds to calibration images of different resolutions under different blur conditions. The process of sliding the tracking template on the matching template from left to right and from top to bottom is only for explanation and does not limit the matching operation mode.

In an optional implementation for determining the direction mapping array corresponding to the gradient direction matrix, a prestored gradient direction matrix corresponding to the calibration data corresponding to the current resolution can be determined. Subsequently, normalization processing is performed on the prestored gradient direction matrix and the gradient direction matrix. Then, a mapping value of each pixel position of the normalized gradient direction matrix in the normalized prestored gradient direction matrix is determined, as well as a direction mapping matrix corresponding to the mapping value. Finally, summation and averaging processing is performed on the mapping relationships of all rows and columns of the direction mapping matrix to obtain the direction mapping array. It should be noted that in the process of determining the mapping value of each pixel position of the normalized gradient direction matrix in the normalized prestored gradient direction matrix, a matching template is also selected in the calibration data and processed. The principle of the processing process is similar to the process of acquiring the magnitude mapping array, and will not be described in detail here.

Step S23: selecting target calibration data having a maximum mapping relationship value from the calibration data based on the magnitude mapping array and the direction mapping array, and determining a calibration parameter corresponding to the target calibration data.

Step S24: performing super-resolution reconstruction processing on the image data based on the calibration parameter to obtain the reconstructed image data.

As an optional implementation, after obtaining the magnitude mapping matrix and the direction mapping matrix, an indoor resolution calibration image $M_r$ with the largest mapping relationship numerical value can be selected from the two:

$$Mr = {α}_{1} \{ r \} + {α}_{2} \{ {r}^{′} \} ;$$

$$Index = arg max ( Mr ) ;$$

where {r} and {r′} are the magnitude mapping relationship array and the direction mapping relationship array respectively, and α₁ and α₂ are weight ratio parameters corresponding to the two arrays respectively. The weight ratio parameters can be dynamically set according to the actual application scenario. After selecting the calibration image Mr, super-resolution reconstruction is performed on the collected beam movement image data based on the super-resolution regression parameter corresponding to Mr.

After performing super-resolution reconstruction processing on the image data, further processing can be performed by means of interpolation reconstruction to improve the image quality, thereby improving the measurement accuracy of the displacement detection result. Specifically, as an optional implementation, interpolation processing can be performed on the reconstructed image data; the reconstructed image data after the interpolation processing is subjected to magnification processing, and all pixel coordinates of the reconstructed image data after the magnification processing are determined; then, based on the integer coordinates and decimal coordinates of all the pixel coordinates, as well as the weight ratios of the integers and decimals, the target pixel coordinates of the reconstructed image data after the magnification processing are calculated.

For example, after performing interpolation processing on the reconstructed image data, it is magnified by equal multiples to a target preset size. Then, based on all positions (x′, y′) of the image, the output high-resolution image position (x, y) is calculated, where x′ and y′ have an integer multiple relationship with x and y. Subsequently, according to the integer parts x_i and y_i of x′ and y′, and the decimal parts dx=x′−xᵢ and dy=y′yᵢ, the weight ratios of 16 pixels around each position are calculated. Then, based on the weights, weighted averaging is performed on the corresponding region of the input image to obtain the value of the pixel (x, y) in the output image.

$$O ( x , y ) = {\sum }_{i = - 1}^{2} {\sum }_{i = - 1}^{2} w ( i , j ) ▯ I ( {x}_{i} + i , {y}_{j} + j ) ;$$

where O(x, y) is the pixel value of the output high-resolution image; I(x′, y′) is the pixel value of the reconstructed image at position (x′, y′) before equal magnification; and w(i, j) is the weight of pixel (xᵢ+i, y_i+j) on the output pixel (x, y). Based on this, the clarity of the image data is improved, so that when performing displacement monitoring analysis, the measurement accuracy of the displacement detection result can be improved.

It should be noted that the above parameters are only for explanation and not a specific limitation of the present application, that is, the number selected in calculating the weight ratios of surrounding multiple pixels can be dynamically set according to the actual application scenario.

Step S30: performing structural vibration magnification processing on the reconstructed image data, and generating a displacement detection result of the measured structure according to the reconstructed image data after the structural vibration magnification processing.

In this embodiment, after performing reconstruction processing on each frame of image of the collected image data and obtaining the reconstructed image data, it is necessary to perform structural minute vibration reconstruction processing to improve the measurement accuracy of the displacement detection result. As an optional implementation, spatial domain decomposition can be performed on each image in the time sequence direction in the vibration video of the laser beam after the super-resolution reconstruction, followed by time domain filtering processing, and then performing magnification and reconstruction on the image data after the time domain filtering processing, thereby completing the structural vibration magnification processing of the reconstructed image data.

In an optional implementation for generating the displacement detection result, a feature region corresponding to the target reconstructed image data can be determined, and target images after the second frame of the reconstructed image data in the feature region are acquired, where the feature region is an imaging region of the projection module. Then, normalization processing is performed on the target images and the first frame image of the target reconstructed image data to obtain a template image corresponding to the feature region and a vibration image corresponding to the first frame image. Subsequently, a mapping value corresponding to a pixel point of the vibration image sliding in the template image is calculated, as well as a mapping matrix corresponding to the mapping value. Then, all frames of the reconstructed image data are processed based on the position corresponding to the maximum value of pixel points in the mapping matrix to obtain a vibration time-history signal of the measured structure, wherein the processor module of the displacement sensing device is capable of generating the displacement detection result based on the vibration time-history signal.

For example, the images from the second frame to the last frame in the image data of the laser beam feature region after the structural vibration magnification processing are selected as the template T, and the first frame image after the reconstruction interpolation processing is used as the vibration template I. Then, normalization processing is performed on the two images respectively to obtain the template image T₁′ and the vibration image I₁′ as shown in the following formula:

$${T}^{′} ( x , y ) = \frac{T ( x , y ) - \frac{1}{w \times h} {\sum }_{{x}^{″} , {y}^{″}} T ( {x}^{″} , {y}^{″} )}{\sqrt{{\sum }_{{x}^{″} , {y}^{″}} {T ( {x}^{″} , {y}^{″} )}^{2}}} ;$$

$${I}^{′} ( x , y ) = \frac{I ( x , y ) - \frac{1}{w \times h} {\sum }_{{x}^{″} , {y}^{″}} I ( {x}^{″} , {y}^{″} )}{\sqrt{{\sum }_{{x}^{″} , {y}^{″}} {I ( {x}^{″} , {y}^{″} )}^{2}}} .$$

Then, the mapping relationship matrix R of the two images is calculated. The implementation process includes sliding the template image T₁′ on the vibration image I₁′ from left to right and from top to bottom, moving one pixel position at a time and calculating the mapping value of the position, to finally calculate and obtain the mapping matrix R:

$$R ( x , y ) = \frac{{\sum }_{{x}^{′} , {y}^{′}} ( {T}^{′} ( {x}^{′} , {y}^{′} ) {I}^{′} ( x + {x}^{′} , y + {y}^{′} ) )}{\sqrt{{\sum }_{{x}^{′} , {y}^{′}} {{T}^{′} ( {x}^{′} , {y}^{′} )}^{2} {\sum }_{{x}^{′} , {y}^{′}} {{I}^{′} ( x + {x}^{′} , y + {y}^{′} )}^{2}}} ;$$

where (x, y) is the coordinate of a certain point on the image to be matched; (x′, y′) is the coordinate of the template image; T(x, y) is the template image with an image size of w W multiplied by h; I is the image to be matched; a point (x, y) on the mapping matrix R(x, y) represents the correlation between an image sub-block in the image to be matched I with (x, y) as the upper-left corner point and the same size as the template image T′(x, y), and T(x, y). It should be noted that the direction of pixel sliding can be dynamically set according to the actual application scenario.

After obtaining the mapping matrix, since the maximum value reflects the similarity and consistency of the image, the position of the maximum value of the mapping matrix is selected as the matching result, and matching processing is performed on each frame of image (i.e., images after the first frame image) in the reconstructed image data after interpolation reconstruction, to finally obtain the vibration time-history signal of the measured structure.

In the technical solution of this embodiment, in the process of performing minute displacement detection on a measured structure based on laser projection, indoor calibration, interpolation reconstruction, and minute vibration magnification processing are associated and combined. Based on the calibration data calibrated indoors in advance, the recognition resolution of the displacement sensing device in actual use is improved. By performing interpolation reconstruction and minute vibration magnification processing, etc., the image clarity and the measurement accuracy of the detection result are further improved. Through the overall combination method, the recognition resolution of the minute vibration at the monitoring position of the measured structure can be significantly improved, realizing high-precision measurement of the minute vibration displacement of the measured structure, and simultaneously improving the measurement accuracy of the minute vibration displacement.

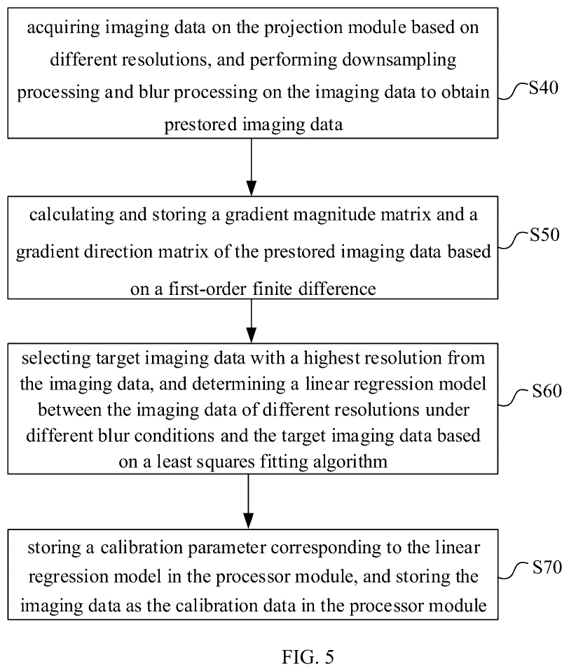

Referring to FIG. 5, in one embodiment, before Step S10, the method further includes:

Step S40: acquiring imaging data on the projection module based on different resolutions, and performing downsampling processing and blur processing on the imaging data to obtain prestored imaging data, wherein the prestored imaging data includes the imaging data of different resolutions and different blur conditions.

In this embodiment, before the displacement sensing device is put into use, a high-resolution camera can be configured to collect beam high-resolution imaging data, and then super-resolution parameter calibration is performed on the laser beam data in advance, thereby effectively improving the recognition resolution of the device in actual use.

In an optional implementation for performing downsampling processing and blur processing on the imaging data, imaging data of the laser beam on the projection module can be acquired respectively based on photography conditions of different resolutions from low to high to obtain multiple groups of projection imaging data of the laser beam with different resolutions. Subsequently, downsampling processing is performed respectively on the acquired images of different resolutions to obtain laser beam imaging data of more resolution conditions. Then, using Gaussian convolution kernels with different scale factors, blur processing is performed on the laser beam imaging data of different resolutions to further expand and obtain laser beam imaging data of different resolutions under different blur scales. In an embodiment, multiple groups of different imaging data can also be collected from high to low.

For example, based on photography conditions of 30-120 frames, multiple groups of projection data of 30, 40, 50 . . . 120 frames are collected, and then multiple downsampling processes are performed thereon to obtain laser beam imaging data including 31, 32, 33, etc., frames. Then, Gaussian convolution processing is performed on the data after sampling processing to obtain imaging data of different blur scales.

Step S50: calculating and storing a gradient magnitude matrix and a gradient direction matrix of the prestored imaging data based on a first-order finite difference.

In this embodiment, by using the first-order finite difference to calculate and store the gradient magnitude matrix and gradient direction matrix of the image under each condition, the processor module can calculate the corresponding mapping array according to these prestored matrices, thereby improving the clarity of the image after super-resolution reconstruction processing.

Step S60: selecting target imaging data with a highest resolution from the imaging data, and determining a linear regression model between the imaging data of different resolutions under different blur conditions and the target imaging data based on a least squares fitting algorithm.

Step S70: storing a calibration parameter corresponding to the linear regression model in the processor module, and storing the imaging data as the calibration data in the processor module, wherein each calibration data corresponds to one said calibration parameter.

In this embodiment, as an optional implementation, taking the imaging data with the highest resolution as a reference, a linear regression model between other imaging data of different resolutions under different blur conditions and the high-resolution imaging data is obtained based on least squares fitting processing. Subsequently, the regression parameter obtained by processing is stored, and the regression parameter is used for image resolution reconstruction processing. Based on this, different regression parameters corresponding to imaging data of different resolutions under different blur conditions can be obtained.

In the technical solution of this embodiment, before the displacement sensing device is put into use, in a stable structure indoors, since the beam or spot image formed by the laser beam on the projection module is fixed, the beam high-resolution imaging data is collected by a high-resolution camera, and the laser beam imaging data is subjected to super-resolution parameter calibration in advance to obtain corresponding calibration data and calibration parameters, which can improve the recognition resolution of the displacement sensing device in actual use.

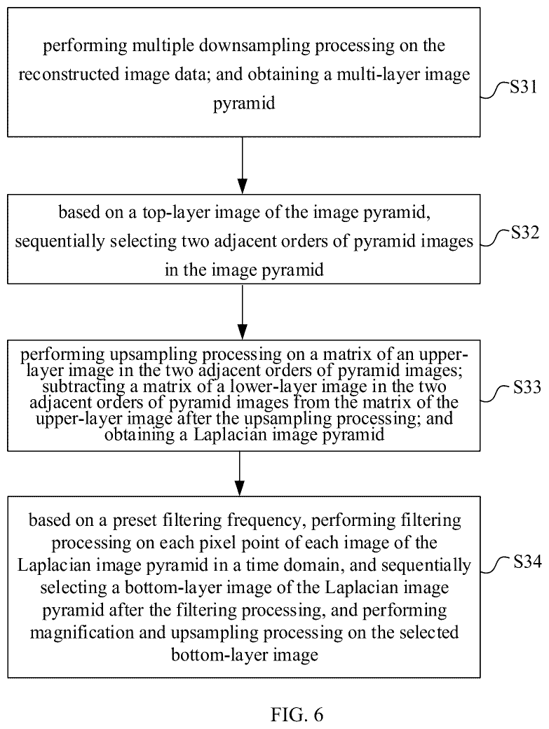

Referring to FIG. 6, in one embodiment, the step of performing structural vibration magnification processing on the reconstructed image data specifically includes:

Step S31: performing multiple downsampling processing on the reconstructed image data to obtain a multi-layer image pyramid.

Step S32: based on a top-layer image of the image pyramid, sequentially selecting two adjacent orders of pyramid images in the image pyramid.

Step S33: performing upsampling processing on a matrix of an upper-layer image in the two adjacent orders of pyramid images, and subtracting a matrix of a lower-layer image in the two adjacent orders of pyramid images from the matrix of the upper-layer image after the upsampling processing to obtain a Laplacian image pyramid.

Step S34: based on a preset filtering frequency, performing filtering processing on each pixel point of each image of the Laplacian image pyramid in a time domain, and sequentially selecting a bottom-layer image of the Laplacian image pyramid after the filtering processing, and performing magnification and upsampling processing on the selected bottom-layer image.

In this embodiment, in the process of performing structural minute vibration reconstruction processing, it is necessary to perform spatial domain decomposition on each image in the time sequence direction in the vibration video of the laser beam after the super-resolution reconstruction.

For example, in a specific implementation scenario, after obtaining the vibration video after super-resolution reconstruction, each frame of image is processed sequentially. In the processing process, the image is first subjected to β downsampling to obtain a β+1 order image pyramid. For the β+1 order image pyramid, starting from the top layer, two adjacent orders of pyramid images are sequentially selected. The upper-layer image matrix in the selected two adjacent orders of pyramid images is subjected to upsampling and then matrix subtraction is performed with the lower-layer image matrix to obtain a Laplacian image pyramid. Then, time domain filtering is performed on the image data of the Laplacian image pyramid. In the processing process, filtering processing is performed sequentially on each pixel point in each said image pyramid in the time domain using an ideal band-pass filter based on a frequency band [f₁, f₂]. Finally, magnification and reconstruction are performed on the image video after filtering processing. In this process, for the image pyramid after filtering, starting from the bottom-layer image, the image pyramid is subjected to a times magnification and upsampling processing level by level, and then superimposed on the upper-layer image pyramid until it is superimposed on the top-layer pyramid image. Based on this, the reconstruction processing of minute vibration is completed, improving the accuracy of minute vibration displacement detection.

In the technical solution disclosed in this embodiment, in the process of performing structural vibration magnification processing on the reconstructed image data, by performing spatial domain decomposition on each image, followed by filtering processing based on the time domain, and finally performing magnification reconstruction, the measurement accuracy of minute displacement detection of the measured structure is improved.

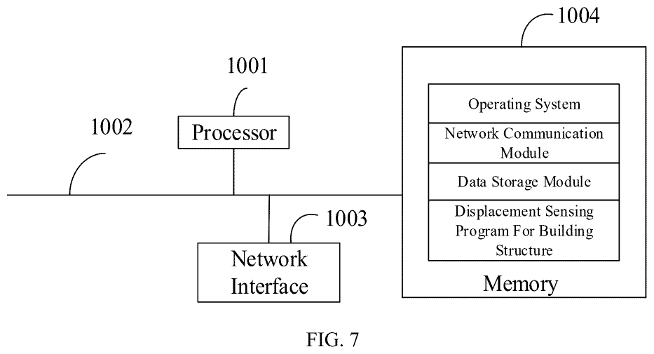

Referring to FIG. 7, FIG. 7 is a schematic structural diagram of a terminal involving the hardware operating environment of the embodiment of the present application.

As shown in FIG. 7, the terminal can include: a processor 1001, such as a Central Processing Unit (CPU), a communication bus 1002, a network interface 1003, and a memory 1004. The communication bus 1002 is configured to implement connection and communication between these components. The network interface 1003 can include a standard wired interface or a wireless interface (such as a Wireless-Fidelity (Wi-Fi) interface). The memory 1004 can be a high-speed Random Access Memory (RAM), or a stable non-volatile memory (NVM), such as a magnetic disk memory. The memory 1004 can also be a storage device independent of the aforementioned processor 1001.

Those skilled in the art can understand that the terminal structure shown in FIG. 7 does not constitute a limitation on the terminal, and may include more or fewer components than shown in the figure, or combine certain components, or have different component arrangements.

As shown in FIG. 7, the memory 1004 as a computer storage medium can include an operating system, a data storage module, a network communication module, and a displacement sensing program for a building structure.

In the terminal shown in FIG. 7, the network interface 1003 is mainly configured to connect to a background server and perform data communication with the background server; the processor 1001 can call the displacement sensing program for the building structure stored in the memory 1004 and execute the following operations:
acquiring image data collected by a camera module and calibration data prestored in a processor module;
performing super-resolution reconstruction processing on the image data according to the calibration data to obtain reconstructed image data; and
performing structural vibration magnification processing on the reconstructed image data, and generating a displacement detection result of a measured structure according to target reconstructed image data after the structural vibration magnification processing.

Further, the processor 1001 can call the displacement sensing program for the building structure stored in the memory 1004 to further perform the following operations:
determining a partial derivative array of the image data, and calculating a gradient magnitude matrix and a gradient direction matrix of the image data according to the partial derivative array;
determining a magnitude mapping array corresponding to the gradient magnitude matrix, and determining a direction mapping array corresponding to the gradient direction matrix;
selecting target calibration data having a maximum mapping relationship value from the calibration data based on the magnitude mapping array and the direction mapping array, and determining a calibration parameter corresponding to the target calibration data;
performing super-resolution reconstruction processing on the image data based on the calibration parameter to obtain the reconstructed image data.

Further, the processor 1001 can call the displacement sensing program for the building structure stored in the memory 1004 to further perform the following operations:
determining a prestored gradient magnitude matrix corresponding to the calibration data corresponding to a current resolution;
performing normalization processing on the prestored gradient magnitude matrix and the gradient magnitude matrix;
determining a mapping value of each pixel position of the normalized gradient magnitude matrix in the normalized prestored gradient magnitude matrix, and a magnitude mapping matrix corresponding to the mapping value; and
performing summation and averaging processing on mapping relationships of all rows and columns of the magnitude mapping matrix to obtain the magnitude mapping array, wherein a mapping relationship feature value of each position of the magnitude mapping array corresponds to the calibration data under different blur conditions and different resolutions.

Further, the processor 1001 can call the displacement sensing program for the building structure stored in the memory 1004 to further perform the following operations:
determining a prestored gradient direction matrix corresponding to the calibration data corresponding to a current resolution;
performing normalization processing on the prestored gradient direction matrix and the gradient direction matrix;
determining a mapping value of each pixel position of the normalized gradient direction matrix in the normalized prestored gradient direction matrix, and a direction mapping matrix corresponding to the mapping value; and
performing summation and averaging processing on mapping relationships of all rows and columns of the direction mapping matrix to obtain the direction mapping array, wherein a mapping relationship feature value of each position of the direction mapping array corresponds to the calibration data under different blur conditions and different resolutions.

Further, the processor 1001 can call the displacement sensing program for the building structure stored in the memory 1004 to further perform the following operations:
acquiring imaging data on the projection module based on different resolutions, and performing downsampling processing and blur processing on the imaging data to obtain prestored imaging data, wherein the prestored imaging data includes the imaging data of different resolutions and different blur conditions;
calculating and storing a gradient magnitude matrix and a gradient direction matrix of the prestored imaging data based on a first-order finite difference;
selecting target imaging data with a highest resolution from the imaging data, and determining a linear regression model between the imaging data of different resolutions under different blur conditions and the target imaging data based on a least squares fitting algorithm; and
storing a calibration parameter corresponding to the linear regression model in the processor module, and storing the imaging data as the calibration data in the processor module, wherein each calibration data corresponds to one calibration parameter.

Further, the processor 1001 can call the displacement sensing program for the building structure stored in the memory 1004 to further perform the following operations:
performing interpolation processing on the reconstructed image data, performing magnification processing on the reconstructed image data after the interpolation processing, and determining all pixel coordinates of the reconstructed image data after the magnification processing;
calculating target pixel coordinates of the reconstructed image data after the magnification processing according to integer coordinates and decimal coordinates of all the pixel coordinates, and weight ratios of integers and decimals.

Further, the processor 1001 can call the displacement sensing program for the building structure stored in the memory 1004 to further perform the following operations:
performing multiple downsampling processing on the reconstructed image data to obtain a multi-layer image pyramid;
based on a top-layer image of the image pyramid, sequentially selecting two adjacent orders of pyramid images in the image pyramid;
performing upsampling processing on a matrix of an upper-layer image in the two adjacent orders of pyramid images, and subtracting a matrix of a lower-layer image in the two adjacent orders of pyramid images from the matrix of the upper-layer image after the upsampling processing to obtain a Laplacian image pyramid; and
based on a preset filtering frequency, performing filtering processing on each pixel point of each image of the Laplacian image pyramid in a time domain, and sequentially selecting a bottom-layer image of the Laplacian image pyramid after the filtering processing, and performing magnification and upsampling processing on the selected bottom-layer image.

Further, the processor 1001 can call the displacement sensing program for the building structure stored in the memory 1004 to further perform the following operations:
determining a feature region corresponding to the target reconstructed image data, and acquiring target images after a second frame of the reconstructed image data in the feature region, wherein the feature region is an imaging region of the projection module;
performing normalization processing on the target images and a first frame image of the target reconstructed image data to obtain a template image corresponding to the feature region and a vibration image corresponding to the first frame image;
calculating a mapping value corresponding to a pixel point of the vibration image sliding in the template image, and a mapping matrix corresponding to the mapping value; and
processing all frames of the target reconstructed image data based on a position corresponding to a maximum value of pixel points in the mapping matrix to obtain a vibration time-history signal of the measured structure, wherein the processor module of the displacement sensing device is capable of generating the displacement detection result based on the vibration time-history signal.

In addition, those of ordinary skill in the art can understand that all or part of the processes in the methods of the above embodiments can be implemented by a computer program instructing relevant hardware. The computer program includes program instructions, and the computer program can be stored in a storage medium, which is a computer-readable storage medium. The program instructions are executed by at least one processor in the control terminal to implement the process steps of the embodiments of the above methods.

Therefore, the present application further provides a computer-readable storage medium, which stores a displacement sensing program for a building structure. When the displacement sensing program for the building structure is executed by a processor, the steps of the displacement sensing method for a building structure described in the above embodiments are implemented.

It should be noted that since the storage medium provided in the embodiment of the present application is the storage medium configured to implement the method of the embodiment of the present application, based on the method introduced in the embodiment of the present application, those skilled in the art can understand the specific structure and modification of the storage medium, so it will not be described in detail here. Any storage medium used in the method of the embodiment of the present application falls within the scope of protection of the present application.

Those skilled in the art should understand that the embodiments of the present application can be provided as a method, a system, or a computer program product. Therefore, the present application can take the form of a completely hardware embodiment, a completely software embodiment, or an embodiment combining software and hardware aspects. Moreover, the present application can take the form of a computer program product implemented on one or more computer-usable storage media (including but not limited to disk memory, CD-ROM, optical memory, etc.) containing computer-usable program code therein.

The present application is described with reference to flowcharts and/or block diagrams of methods, devices (systems), and computer program products according to embodiments of the present application. It should be understood that each flow and/or block in the flowcharts and/or block diagrams, and combinations of flows and/or blocks in the flowcharts and/or block diagrams can be implemented by computer program instructions. These computer program instructions can be provided to a processor of a general-purpose computer, a special-purpose computer, an embedded processor, or other programmable data processing equipment to generate a machine, so that instructions executed by the processor of the computer or other programmable data processing equipment generate an apparatus for implementing functions specified in one or more flows in a flowchart and/or one or more blocks in a block diagram.

These computer program instructions can also be stored in a computer-readable memory capable of guiding a computer or other programmable data processing equipment to work in a specific manner, so that the instructions stored in the computer-readable memory generate a manufactured product including an instruction apparatus, and the instruction apparatus implements functions specified in one or more flows in a flowchart and/or one or more blocks in a block diagram.

These computer program instructions can also be loaded onto a computer or other programmable data processing equipment, so that a series of operation steps are executed on the computer or other programmable equipment to produce computer-implemented processing, whereby the instructions executed on the computer or other programmable equipment provide steps for implementing functions specified in one or more flows in a flowchart and/or one or more blocks in a block diagram.

It should be noted that in the claims, any reference signs placed between parentheses should not be construed as limiting the claim. The word “comprising” does not exclude the presence of components or steps not listed in the claim. The word “a” or “an” preceding a component does not exclude the presence of a plurality of such components. The present application can be implemented by means of hardware including several different components and by means of a suitably programmed computer. In the unit claims enumerating several devices, several of these devices can be embodied by the same item of hardware. The use of the words first, second, and third, etc. does not indicate any order. These words can be interpreted as names.

Although optional embodiments of the present application have been described, those skilled in the art can make other changes and modifications to these embodiments once they learn the basic inventive concept. Therefore, the appended claims are intended to be interpreted as including optional embodiments and all changes and modifications falling within the scope of the present application.

Obviously, those skilled in the art can make various changes and modifications to the present application without departing from the spirit and scope of the present application. Thus, if these modifications and variations of the present application fall within the scope of the claims of the present application and their equivalents, the present application is also intended to include these modifications and variations.

The above are only optional embodiments of the present application and are not intended to limit the patent scope of the present application. Any equivalent structure or equivalent process transformation made using the content of the specification and drawings of the present application, or directly or indirectly applied in other related technical fields, is similarly included in the scope of the present application.

What is claimed is:

1. A displacement sensing method for a building structure, applied to a displacement sensing device for a building structure, wherein the displacement sensing device comprises a fixed module, a projection module, a camera module and a processor module; the fixed module comprises a fixed base and a fixed bracket, the fixed base is configured to be coupled with a monitoring point of a measured structure to form a structural whole; the camera module is disposed in front of the projection module at an angle of a vertical field of view via the fixed bracket and the camera module is configured to acquire a laser image formed on the projection module by a laser emission module disposed at a fixed point; and the processor module is configured to acquire image data collected by the camera module and generate a displacement detection result according to the image data; the displacement sensing method for the building structure comprises:
acquiring the image data collected by the camera module and calibration data prestored in the processor module;
determining a partial derivative array of the image data, and calculating a gradient magnitude matrix and a gradient direction matrix of the image data according to the partial derivative array;
determining a magnitude mapping array corresponding to the gradient magnitude matrix, and determining a direction mapping array corresponding to the gradient direction matrix;
selecting target calibration data having a maximum mapping relationship value from the calibration data based on the magnitude mapping array and the direction mapping array, and determining a calibration parameter corresponding to the target calibration data;
performing super-resolution reconstruction processing on the image data based on the calibration parameter to obtain reconstructed image data; and
performing structural vibration magnification processing on the reconstructed image data, and generating a displacement detection result of the measured structure according to the target reconstructed image data after the structural vibration magnification processing.

2. The displacement sensing method for the building structure according to claim 1, wherein the determining the magnitude mapping array corresponding to the gradient magnitude matrix comprises:
determining a prestored gradient magnitude matrix corresponding to the calibration data corresponding to a current resolution;
performing normalization processing on the prestored gradient magnitude matrix and the gradient magnitude matrix;
determining a mapping value of each pixel position of the normalized gradient magnitude matrix in the normalized prestored gradient magnitude matrix, and a magnitude mapping matrix corresponding to the mapping value; and
performing summation and averaging processing on mapping relationships of all rows and columns of the magnitude mapping matrix to obtain the magnitude mapping array, wherein a mapping relationship feature value of each position of the magnitude mapping array corresponds to the calibration data under different blur conditions and different resolutions.

3. The displacement sensing method for the building structure according to claim 1, wherein the determining the direction mapping array corresponding to the gradient direction matrix comprises:
determining a prestored gradient direction matrix corresponding to the calibration data corresponding to a current resolution;
performing normalization processing on the prestored gradient direction matrix and the gradient direction matrix;
determining a mapping value of each pixel position of the normalized gradient direction matrix in the normalized prestored gradient direction matrix, and a direction mapping matrix corresponding to the mapping value; and
performing summation and averaging processing on mapping relationships of all rows and columns of the direction mapping matrix to obtain the direction mapping array, wherein a mapping relationship feature value of each position of the direction mapping array corresponds to the calibration data under different blur conditions and different resolutions.

4. The displacement sensing method for the building structure according to claim 1, wherein before the acquiring the image data collected by the camera module and calibration data prestored in the processor module, the method further comprises:
acquiring imaging data on the projection module based on different resolutions, and performing downsampling processing and blur processing on the imaging data to obtain prestored imaging data, wherein the prestored imaging data comprises the imaging data of different resolutions and different blur conditions;
calculating and storing a gradient magnitude matrix and a gradient direction matrix of the prestored imaging data based on a first-order finite difference;
selecting target imaging data with a highest resolution from the imaging data, and determining a linear regression model between the imaging data of different resolutions under different blur conditions and the target imaging data based on a least squares fitting algorithm; and
storing a calibration parameter corresponding to the linear regression model in the processor module, and storing the imaging data as the calibration data in the processor module, wherein each calibration data corresponds to one calibration parameter.

5. The displacement sensing method for the building structure according to claim 1, wherein after the performing super-resolution reconstruction processing on the image data based on the calibration parameter to obtain reconstructed image data, the method further comprises:
performing interpolation processing on the reconstructed image data, performing magnification processing on the reconstructed image data after the interpolation processing, and determining all pixel coordinates of the reconstructed image data after the magnification processing; and
calculating target pixel coordinates of the reconstructed image data after the magnification processing according to integer coordinates and decimal coordinates of all the pixel coordinates, and weight ratios of integers and decimals.

6. The displacement sensing method for the building structure according to claim 1, wherein the generating the displacement detection result of the measured structure according to the target reconstructed image data after the structural vibration magnification processing comprises:
determining a feature region corresponding to the target reconstructed image data, and acquiring target images after a second frame of the reconstructed image data in the feature region, wherein the feature region is an imaging region of the projection module;
performing normalization processing on the target images and a first frame image of the target reconstructed image data to obtain a template image corresponding to the feature region and a vibration image corresponding to the first frame image;
calculating a mapping value corresponding to a pixel point of the vibration image sliding in the template image, and a mapping matrix corresponding to the mapping value; and
processing all frames of the target reconstructed image data based on a position corresponding to a maximum value of pixel points in the mapping matrix to obtain a vibration time-history signal of the measured structure, wherein the processor module of the displacement sensing device is capable of generating the displacement detection result based on the vibration time-history signal.

7. The displacement sensing method for the building structure according to claim 1, wherein the calibration data is accurate data for reference measured indoors before installing the displacement sensing device on the building structure to be measured.

8. The displacement sensing method for the building structure according to claim 1, wherein the determining the partial derivative array of the image data comprises:
calculating the partial derivative array of the image data through a first-order finite difference to respectively obtain image partial derivative arrays along x and y directions.

9. The displacement sensing method for the building structure according to claim 8, wherein the calculating the gradient magnitude matrix and the gradient direction matrix of the image data according to the partial derivative array comprises:
combining the image partial derivative arrays along x and y directions to calculate an image gradient array, and sequentially obtaining the gradient magnitude matrix and the gradient direction matrix of a frame image according to processing of a vibration image corresponding to a first frame image.

10. The displacement sensing method for the building structure according to claim 2, wherein the current resolution is a resolution corresponding to when the camera module acquires the image data of the projection module.

11. The displacement sensing method for the building structure according to claim 1, wherein the generating the displacement detection result of the measured structure according to the reconstructed image data after the structural vibration magnification processing comprises:
performing spatial domain decomposition and time domain filtering processing on each image in a time sequence direction in a vibration video of a laser beam after the super-resolution reconstruction; and performing magnification and reconstruction on image data after the time domain filtering processing.

12. The displacement sensing method for the building structure according to claim 2, wherein the performing downsampling processing and blur processing on the imaging data comprises:
respectively acquiring imaging data of a laser beam on the projection module based on photography conditions of different resolutions from low to high; and obtaining multiple groups of projection imaging data of the laser beam with different resolutions.

13. The displacement sensing method for the building structure according to claim 12, wherein after the obtaining multiple groups of projection imaging data of the laser beam with different resolutions, the method further comprises:
performing downsampling processing respectively on the multiple groups of acquired projection imaging data of the laser beam with different resolutions to obtain laser beam imaging data of more resolution conditions.

14. The displacement sensing method for the building structure according to claim 13, wherein the performing downsampling processing and blur processing on the imaging data further comprises: using Gaussian convolution kernels with different scale factors to perform blur processing on the laser beam imaging data of different resolutions, to expand and obtain imaging data of the laser beam with different resolutions under different blur scales.

15. The displacement sensing method for the building structure according to claim 1, wherein the performing structural vibration magnification processing on the reconstructed image data comprises: performing multiple downsampling processing on the reconstructed image data;
and obtaining a multi-layer image pyramid.

16. The displacement sensing method for the building structure according to claim 15, wherein after the obtaining the multi-layer image pyramid, the method further comprises: based on a top-layer image of the image pyramid, sequentially selecting two adjacent orders of pyramid images in the image pyramid.

17. The displacement sensing method for the building structure according to claim 16, wherein after the based on the top-layer image of the image pyramid, sequentially selecting two adjacent orders of pyramid images in the image pyramid, the method further comprises:
performing upsampling processing on a matrix of an upper-layer image in the two adjacent orders of pyramid images; subtracting a matrix of a lower-layer image in the two adjacent orders of pyramid images from the matrix of the upper-layer image after the upsampling processing; and obtaining a Laplacian image pyramid.

18. The displacement sensing method for the building structure according to claim 17, wherein after the obtaining the Laplacian image pyramid, the method further comprises:
based on a preset filtering frequency, performing filtering processing on each pixel point of each image of the Laplacian image pyramid in a time domain, and sequentially selecting a bottom-layer image of the Laplacian image pyramid after the filtering processing, and performing magnification and upsampling processing on the selected bottom-layer image.
